(19) United States
(12) Patent Application Publication
(10) Pub. No.: US 2005/0250078 A1
(43) Pub. Date: Nov. 10, 2005

(54) Dase system: Dickinson Amidon sign encoding system

(76) Inventor: Holly Dickinson Amidon, Andover, MA (US)

Correspondence Address: Dahl & Osterloth, LLP;Suite 3405, 555 17th Street, Denver, CO, 80202, US

(21) Appl. No.: 11/122,852

(22) Filed: May 4, 2005

Related U.S. Application Data
(60) Provisional application No. 60/568,012, filed on May 4, 2004.

(51) Int. Cl. G09B 21/00

(52) U.S. Cl. 434/112

(57) ABSTRACT

Visual and kinetic educational systems and methods are disclosed for promoting literacy for users of American Sign Language (ASL). Embodiments of the systems and methods give ASL a lasting visual component. Embodiments provided include sandpaper handshapes, object bags, a moveable sign encoding system, and a grammar system. There are provided systems and methods for encoding and decoding American Sign Language. These are designed to meet the unique learning needs of severely/profoundly, prelingually deafened children. Exemplary embodiments drastically modify the phonetically based Montessori Language Curriculum making the Montessori Method available for use with severely/profoundly, prelingually deafened children.

### REFERENCE TO PENDING PRIOR PATENT APPLICATION

This patent application claims benefit of pending prior U.S. Provisional Patent Application Ser. No. 60/568,012, filed May, 04, 2004 by Holly Dickinson Amidon for MONTESSORI LANGUAGE CURRICULUM ADAPTED FOR USE WITH AMERICAN SIGN LANGUAGE, which patent application is hereby incorporated herein by reference.

### BACKGROUND

“Communication”, which is broader than “language”, generally is defined as any behavior involving the transmission of information between two people. Language is one type of communication.

Grammar, which is the structure of language, generally comprises phonology, syntax, semantics, and pragmatics. Phonology is how sounds go together in a spoken language to forms words or how the elements of handshape, location, orientation and movement in a signed language combine to form signs. Syntax is how words or signs are organized in sentences. Semantics is how to interpret the meaning of words or signs and sentences. Pragmatics is how to participate in a conversation; including turn taking and anticipating needed information while engaged in everyday discourse.

Research shows that a Deaf native user of sign language thinks and dreams in signs. Deaf Americans who use sign language predominately use American Sign Language (ASL). ASL is the most researched of all sign languages used in the world.

Language development for the Deaf child may be different than other children. For a Deaf child with parents that use sign language from the time of the child's birth, language development in sign language should follow essentially the same course as speech development in hearing children. However, it is often difficult for Deaf children to learn to read and write in a second language, such as English, because sign language does not have a written format, which is true for many spoken languages used in other parts of the world, such as Swahili. Therefore, it would be desirable to have a sign encoding system which provides a visual grammatical framework of American Sign Language (ASL).

### SUMMARY OF THE INVENTION

Visual and kinetic educational systems and methods are disclosed for promoting literacy for users of American Sign Language (ASL). Embodiments of the systems and methods give ASL a lasting visual component. There is provided four components, which include sandpaper handshapes, object bags, a moveable sign encoding system, and a grammar system. One embodiment features a newly created method, referred to herein as the Dickinson Amidon Sign Encoding system, or the DASE system for encoding and decoding American Sign Language. The DASE System is designed to meet the unique learning needs of severely/profoundly, prelingually deafened children. An associated curriculum, referred to as “The Montessori Language Curriculum Adapted for use with American Sign Language” is a comprehensive work that takes the phonetically based Montessori Language Curriculum and completely modifies it for use with severely/profoundly, prelingually deafened children. The academic rationale, which is provided in U.S. Provisional Patent Application Ser. No. 60/568,012, and is hereby incorporated herein by reference, contains a review of past and present research regarding the language acquisition of deaf children, the history of deaf education, the syntactical structure of sign, and the Montessori Method as it applies to hearing and deaf children.

Other embodiments are also disclosed.

### BRIEF DESCRIPTION OF THE DRAWINGS

Illustrative embodiments of the invention are illustrated in the drawings, in which:

FIGS. 1-43 illustrate two-dimensional handshape configurations, which are graphical symbols and are used in learning ASL, or any other standardized sign language, i.e. French Sign Language, by capitalizing on the visual and tactile senses in a tangible format thus supporting long-term memory;

FIGS. 44-46 illustrate three-dimensional handshapes configured for use in learning and using ASL in a tangible format;

FIG. 47 illustrates sandpaper letters from the existing Montessori Language Curriculum configured for learning English via the visual, auditory and tactile senses;

FIG. 48 illustrates three individual three-dimensional handshapes mounted together with two-dimensional sandpaper letters;

FIGS. 49 and 50 illustrate three-dimensional handshapes mounted together with two-dimensional sandpaper handshapes;

FIGS. 51 and 52 illustrate partial contents of two sets of object bags paired with elements of the Moveable Sign Encoding System;

FIGS. 53A-53D illustrate lists of items grouped together with one another for use in object bags using similar handshapes;

FIG. 54 illustrates a moveable alphabet consisting of the 26 English letters from the Montessori Language Curriculum;

FIG. 55 illustrates a use of the moveable alphabet shown in FIG. 54;

FIG. 56 illustrates an embodiment of a moveable manual alphabet;

FIG. 57 illustrates an embodiment of the moveable sign encoding system (MSES) and its cabinet;

FIG. 58 illustrates an embodiment of the movement symbols, an element of the moveable sign encoding system, shown in FIGS. 57 and 59;

FIGS. 59 and 60 illustrate exemplary uses of the moveable sign encoding system;

FIG. 61 illustrates an embodiment of a grammar system for use with ASL;

FIG. 62 illustrates the use of the Montessori grammar system for English; and

FIGS. 63-68 illustrate sentences utilizing the moveable sign encoding system, which incorporates the ASL grammar system shown in FIG. 61.

### DETAILED DESCRIPTION OF AN EMBODIMENT

Embodiments of the invention provide a key tool in the development of ASL grammar for Deaf Individuals according to the Montessori Language Curriculum. Various embodiments include sandpaper handshapes, object bags, a moveable sign encoding system, grammar boxes, and a moveable manual alphabet. Each of these embodiments is designed to provide sign language with clear and lasting visual components, which allows a Deaf person to see his or her language in a permanent form.

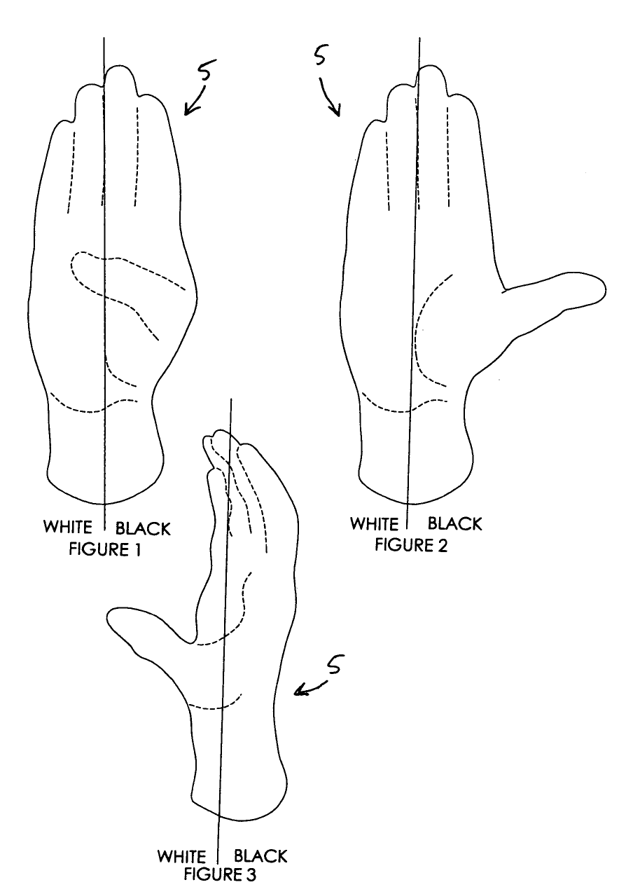

Referring to FIGS. 1-43, 49 and 50, there is shown several embodiments of sandpaper handshapes 5.

Referring to FIGS. 1-43, there is shown a set of sandpaper handshapes 5 configured for use with ASL and with various embodiments disclosed herein. These handshapes correspond to the over 41 handshapes of American Sign Language.

Referring to FIGS. 44-46 and 48-50, and in several embodiments, handshapes 10 are provided in a 3-D form. 3-D handshapes 10 may be made of plastic or wood. 3-D handshapes 10 are designed to introduce from one to four components of a sign. The components of a sign are handshape, orientation, location, and movement. 3-D handshapes 10 are designed to encourage increased motor function and planning. Handshape generally refers to one of the over 41 hand embodiments indicative of the human hand found in ASL. For the three-dimensional format of at least 41 handshapes from American Sign Language, the handshapes are child's-sized, carved from wood or plastic and sit on a wooden base that displays the corresponding two-dimensional handshapes cut from sandpaper. In an exemplary embodiment, the two-dimensional handshapes are die cut from white sandpaper.

In one embodiment, 26 handshapes of the manual alphabet are created in 3-dimensional format from wood or plastic. Each handshape is created from a child-size mold and sits on a base. The corresponding colored sandpaper letter 15 is adhered to the base of each manual handshape; therefore creating a connection between the manual and English alphabets 25. The color blue indicates that the letter is a vowel and the color red/pink indicates that it is a consonant.

The use of the manual sandpaper alphabet gives the child another sense experience to associate with the English letters of fingerspelling, which is a subset of ASL. This material was created for use after a foundation of ASL literacy has been established. It acts as a bridge between the visual aspects of ASL and the auditory aspects of English. This is to be incorporated after the DASE System has been mastered.

Referring again to FIGS. 1-43, there is shown handshapes 5 created in 2-D form from die cuts. In one embodiment, 2-D handshapes 5 are created from sandpaper. In other embodiments, 2-D handshapes 5 are created from other materials.

In an embodiment, 2-D handshapes 5 each provide a spatial orientation of where the hand is located in space, which incorporates three (3) of the four (4) components of a sign. Specifically, the white, black and ½ black-½ white variants of handshape 5 indicate the orientation of a sign from the perspective of the signer, never from the perspective of the recipient. This configuration is useful when encoding and/or decoding ASL. The purpose is to indicate if the palm is facing the signer (white), or if the back of the hand is facing the signer (black), or if a side view of the hand is present (½ black-½ white). The intent of 20 is to provide a connection between the 2-D 5 and 3-D 10 forms of the handshapes.

FIG. 1 is a two dimensional representation for the handshape “B”.

FIG. 2 is a two dimensional representation for the handshape “open B”.

FIG. 3 is a two dimensional representation for the handshape “C”.

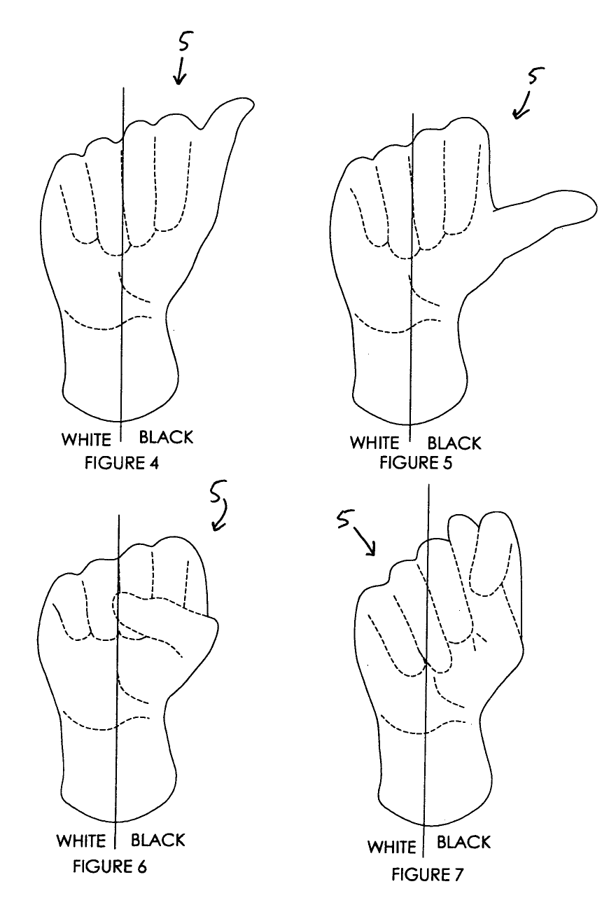

FIG. 4 is a two dimensional representation for the handshape “A”.

FIG. 5 is a two dimensional representation for the handshape “open A”.

FIG. 6 is a two dimensional representation for the handshape “S”.

FIG. 7 is a two dimensional representation for the handshape “T”.

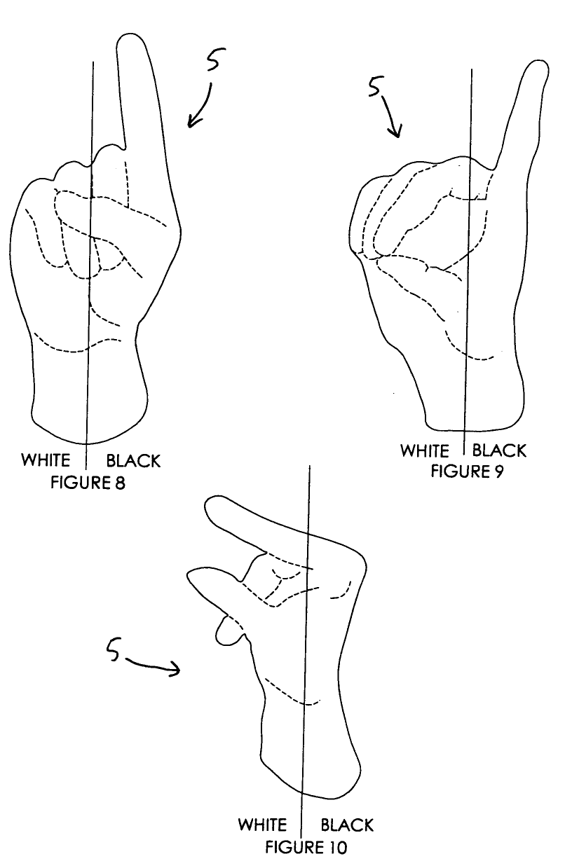

FIG. 8 is a two dimensional representation for the handshape “1”.

FIG. 9 is a two dimensional representation for the handshape “D”.

FIG. 10 is a two dimensional representation for the handshape “G”.

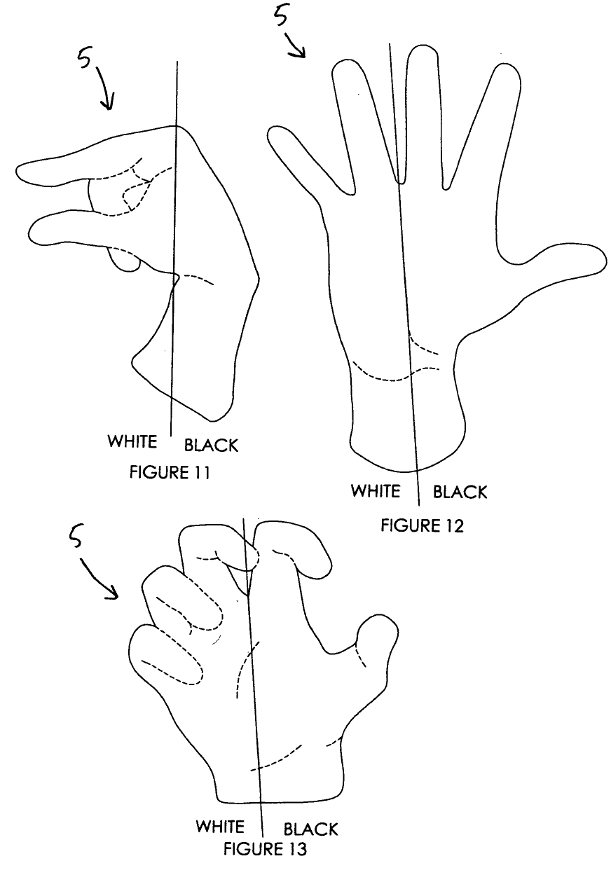

FIG. 11 is a two dimensional representation for the handshape “Q”.

FIG. 12 is a two dimensional representation for the handshape “5”.

FIG. 13 is a two dimensional representation for the handshape “claw 5”.

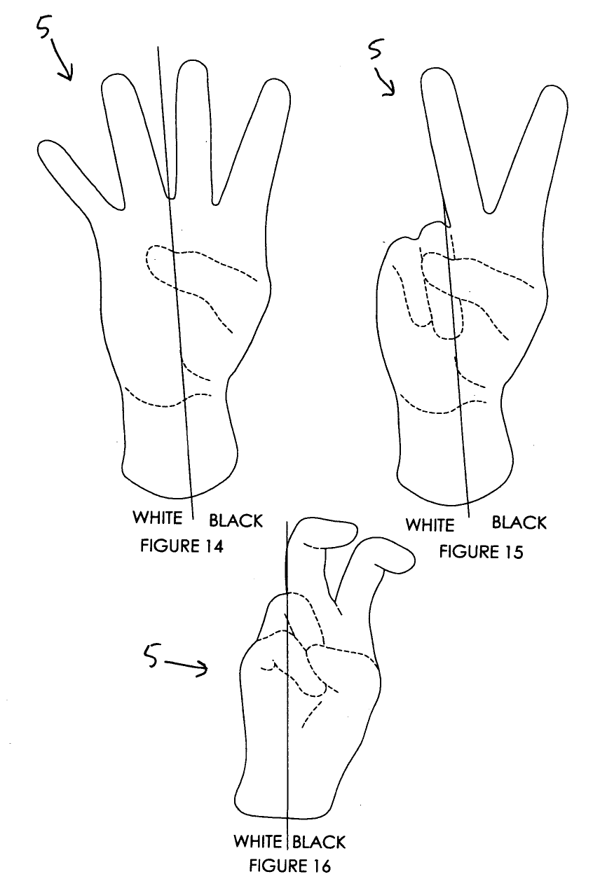

FIG. 14 is a two dimensional representation for the handshape “4”.

FIG. 15 is a two dimensional representation for the handshape “V”.

FIG. 16 is a two dimensional representation for the handshape “bent 2/bent V”.

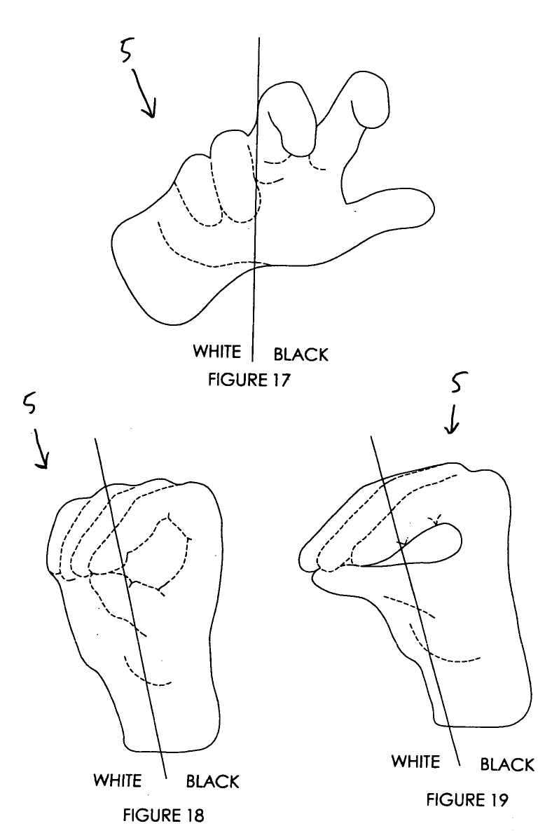

FIG. 17 is a two dimensional representation for the handshape “claw 3”.

FIG. 18 is a two dimensional representation for the handshape “O”.

FIG. 19 is a two dimensional representation for the handshape “flat O”.

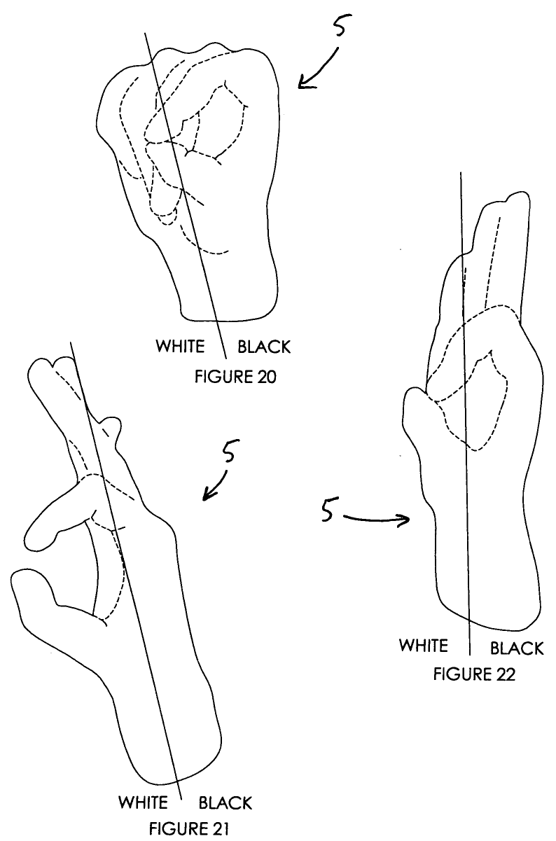

FIG. 20 is a two dimensional representation for the handshape “baby O”.

FIG. 21 is a two dimensional representation for the handshape “open F”.

FIG. 22 is a two dimensional representation for the handshape “F”.

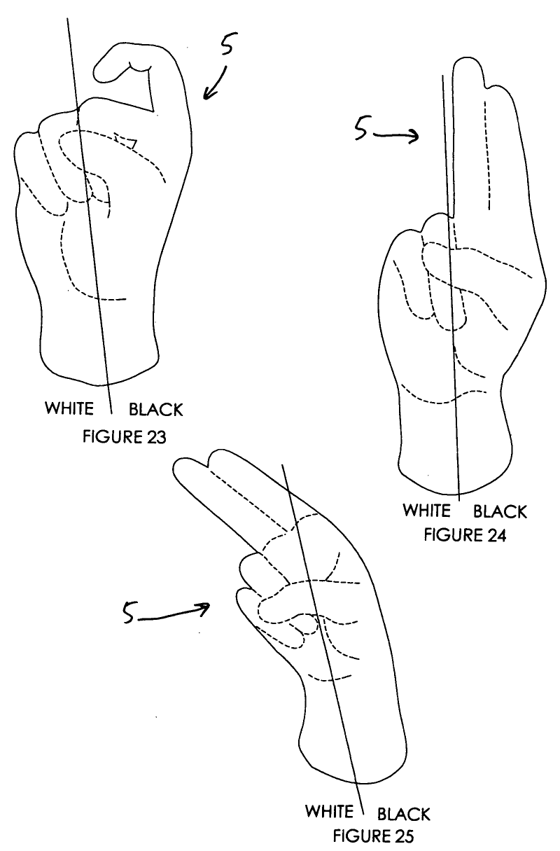

FIG. 23 is a two dimensional representation for the handshape “bent L”.

FIG. 24 is a two dimensional representation for the handshape “U”.

FIG. 25 is a two dimensional representation for the handshape “H”.

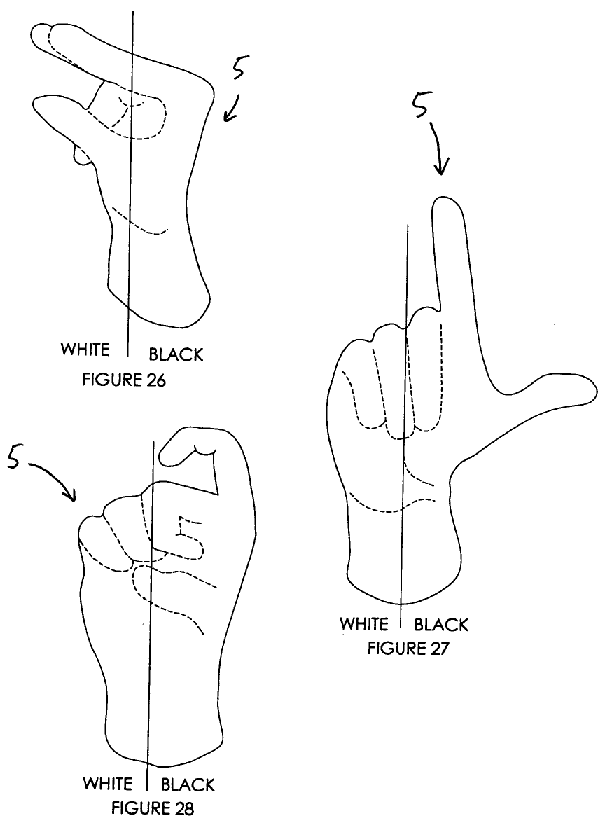

FIG. 26 is a two dimensional representation for the handshape “open N”.

FIG. 27 is a two dimensional representation for the handshape “L”.

FIG. 28 is a two dimensional representation for the handshape “X”.

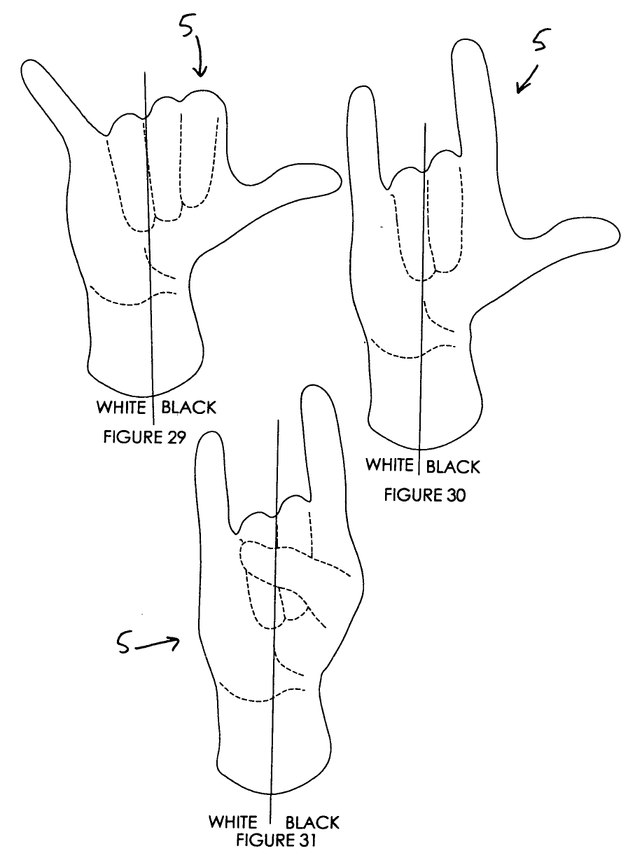

FIG. 29 is a two dimensional representation for the handshape “Y”.

FIG. 30 is a two dimensional representation for the handshape “I-L”.

FIG. 31 is a two dimensional representation for the handshape “I-1”.

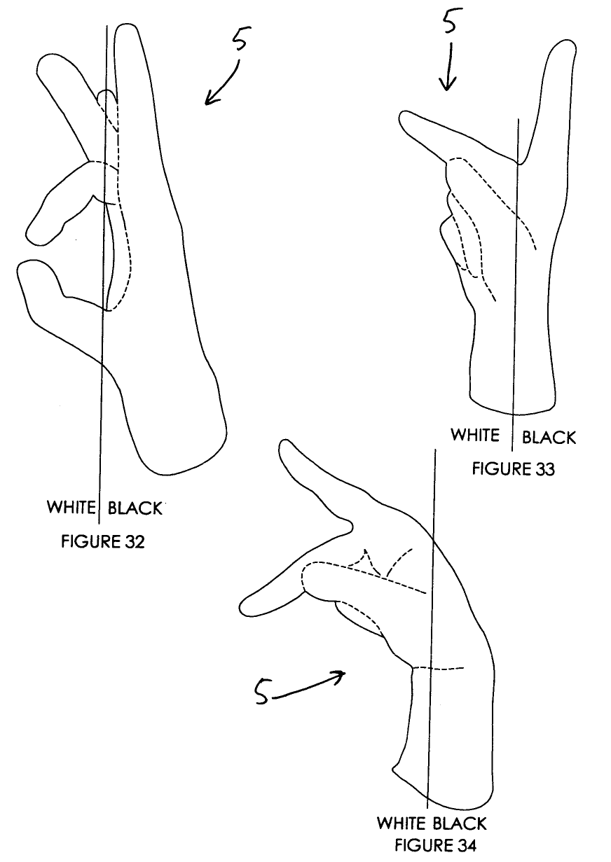

FIG. 32 is a two dimensional representation for the handshape “open 8”.

FIG. 33 is a two dimensional representation for the handshape “K”.

FIG. 34 is a two dimensional representation for the handshape “P”.

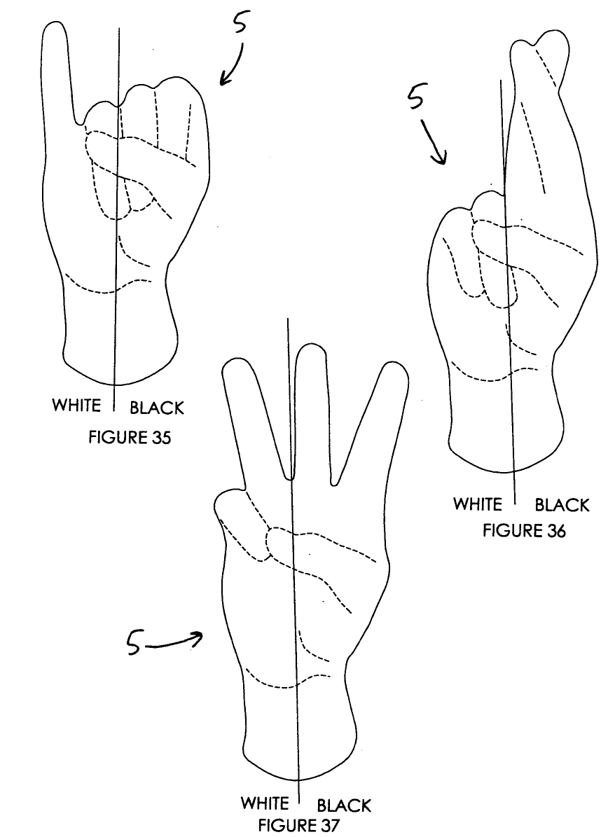

FIG. 35 is a two dimensional representation for the handshape “I”.

FIG. 36 is a two dimensional representation for the handshape “R”.

FIG. 37 is a two dimensional representation for the handshape “W”.

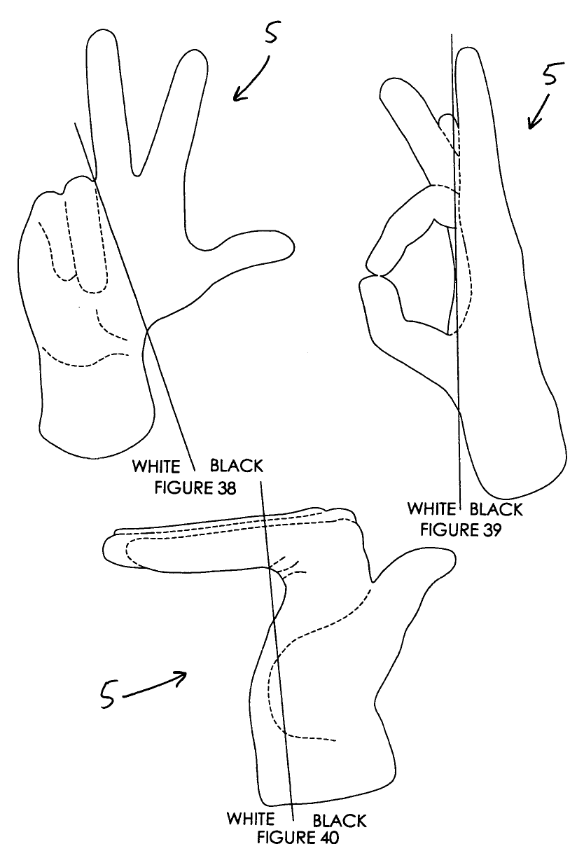

FIG. 38 is a two dimensional representation for the handshape “3”.

FIG. 39 is a two dimensional representation for the handshape “8”.

FIG. 40 is a two dimensional representation for the handshape “bent B”.

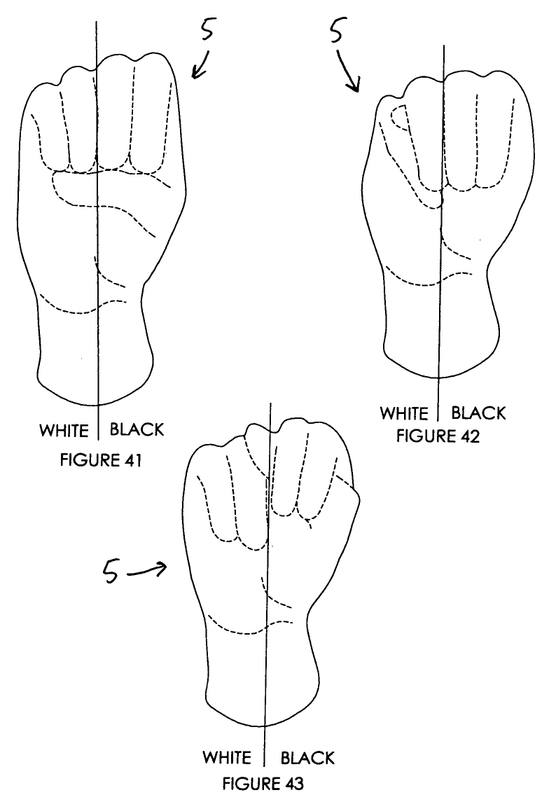

FIG. 41 is a two dimensional representation for the handshape “E”.

FIG. 42 is a two dimensional representation for the handshape “M”.

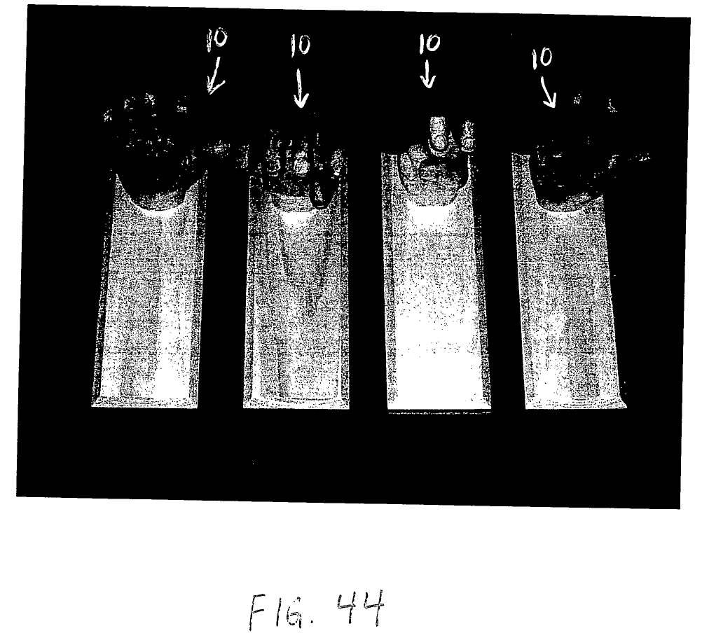

FIG. 43 is a two dimensional representation for the handshape “N”.

Looking at FIG. 44, there is shown four individual 3-D handshapes 10. From left to right, the 3-D handshapes 10 represent the handshape “5”, the handshape “claw 5”, the handshape “bent 2/bent V”, and the handshape “3”.

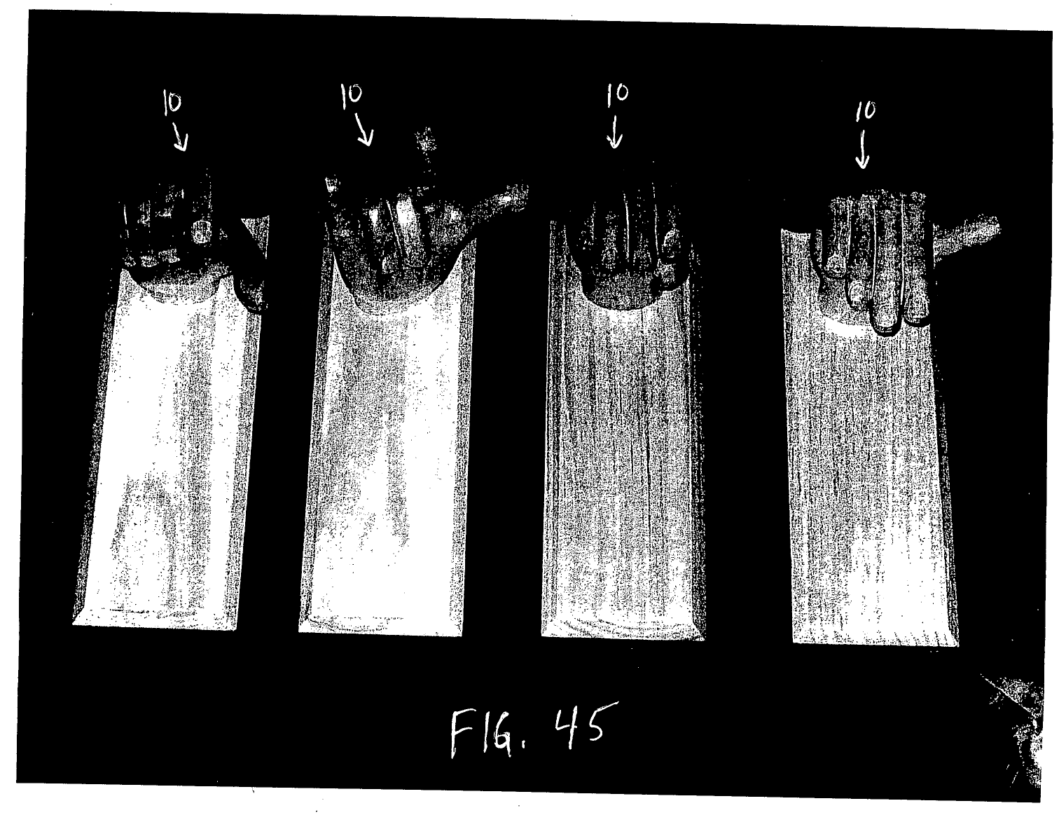

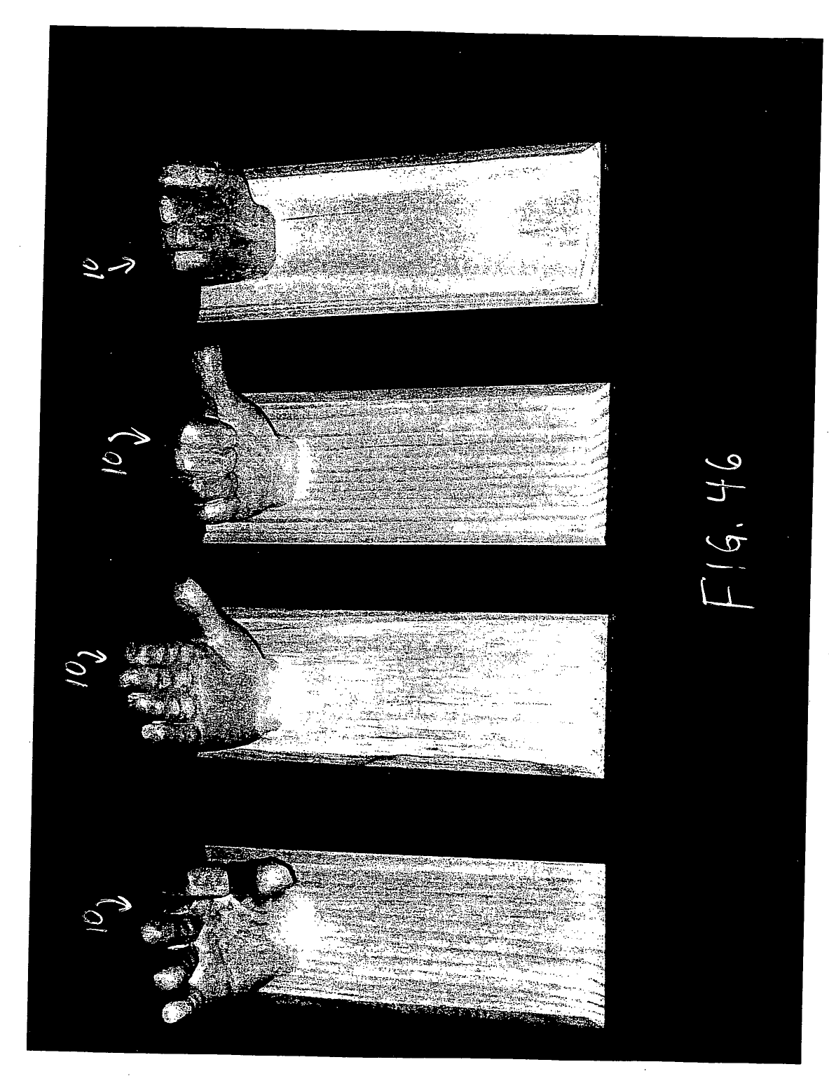

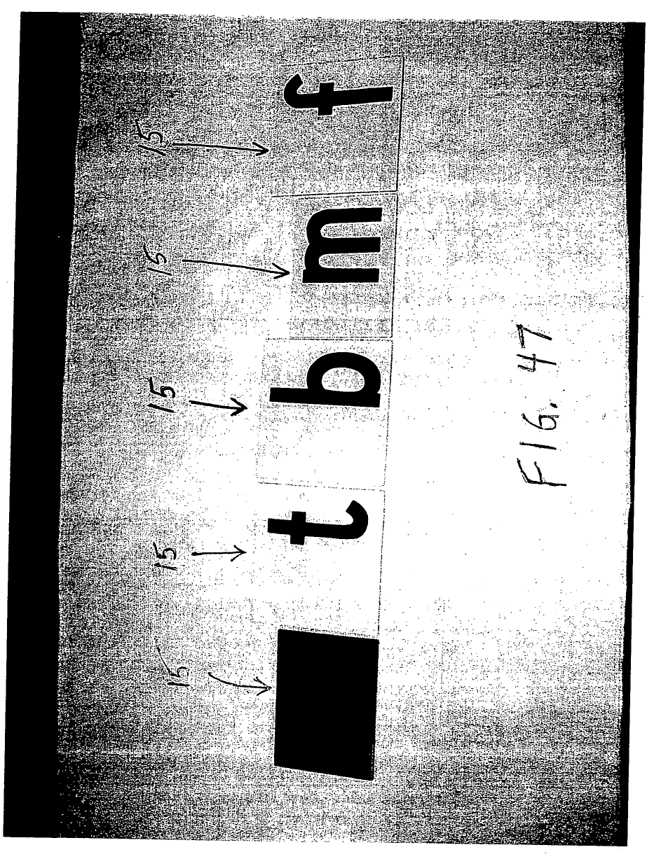

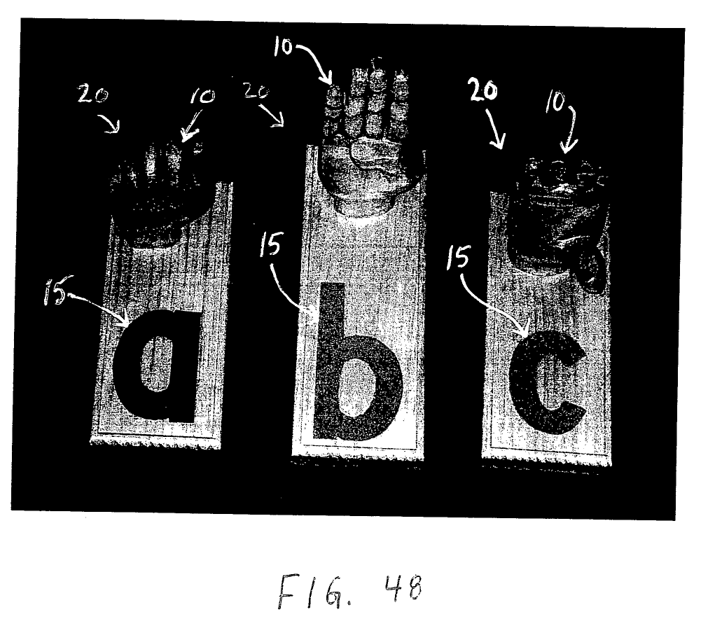

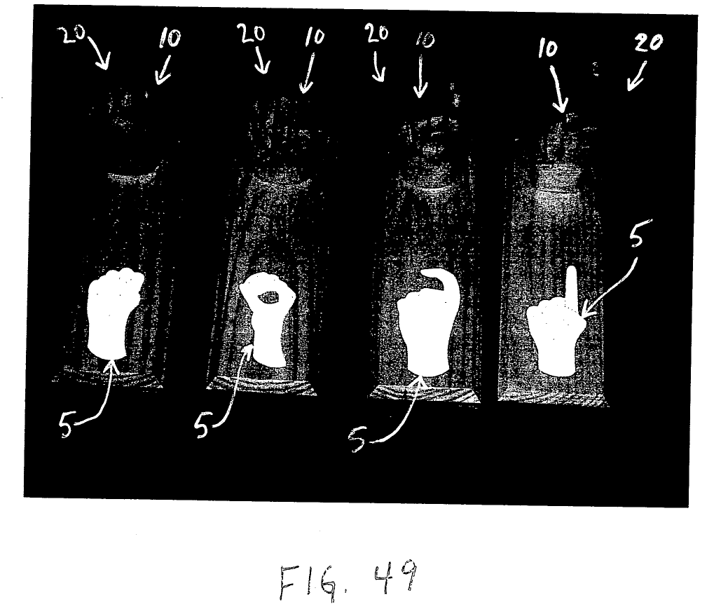

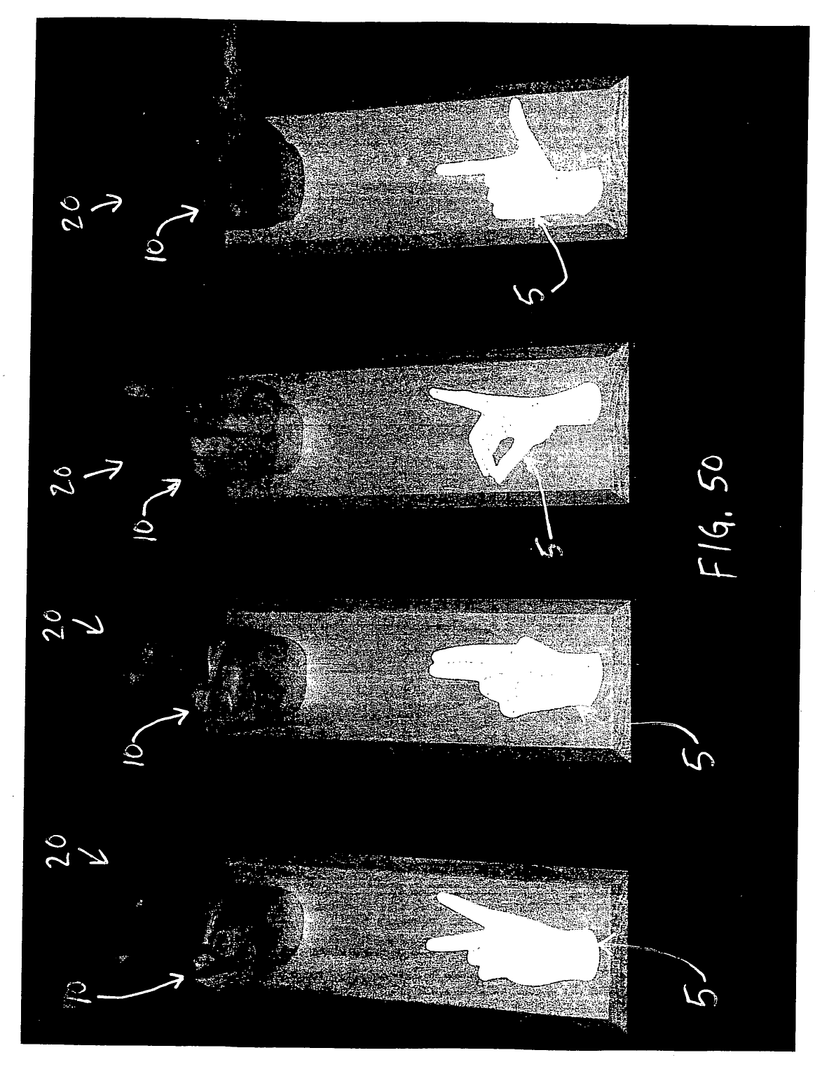

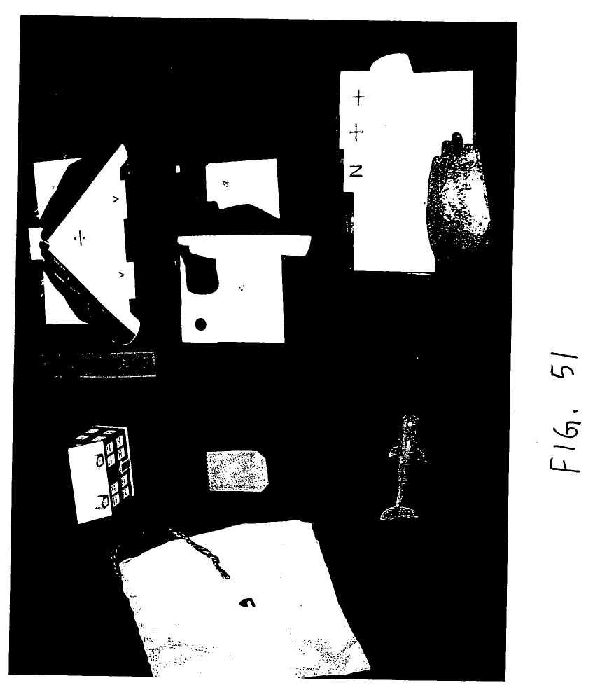

Looking at FIG. 45, there is shown four individual 3-D handshapes 10. From left to right, the 3-D handshapes 10 represent the handshape “g”, the handshape “i-I”, the handshape “flat o”, and the handshape “bent b”.

Looking at FIG. 46, there is shown four individual 3-D handshapes 10. From left to right, the 3-D handshapes 10 represent the handshape “open f”, the handshape “open b”, the handshape “open a”, and the handshape “baby o”.

Looking at FIG. 47, there is shown sandpaper letters 15 from the existing Montessori Language Curriculum, which include the English letters “a”, “t”, “b”, “m”, and “f”, respectively.

Looking at FIG. 48, there is shown three individual 3-D handshapes 10 mounted together with sandpaper letters 15, which represent the English letters “a”, “b” and “c”, respectively. These groups of manual sandpaper letters 25 links fingerspelling with their English counterparts.

Looking at FIG. 49, there is shown four individual 3-D handshapes 10 mounted together with sandpaper handshapes 5, which represent the ASL handshapes “s”, “o”, “x”, and “1”, respectively. These groups of sandpaper handshapes 20 links the 2-D 5 and 3-D 10 formats of the 41+ handshapes of ASL.

Looking at FIG. 50, there is shown four individual 3-D handshapes 10 mounted together with sandpaper handshapes 5, which represent the ASL handshapes “v”, “u”, “d”, and “I”, respectively. These groups of sandpaper handshapes 20 links the 2-D 5 and 3-D 10 formats of the 41+ handshapes of ASL.

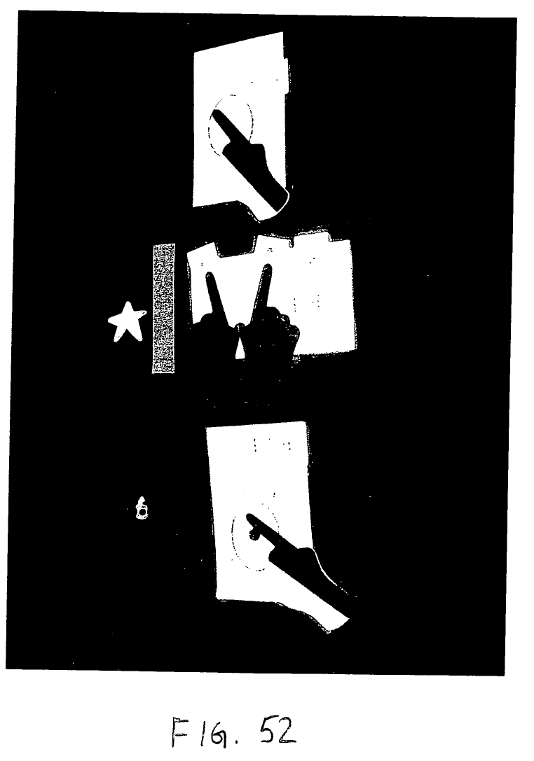

Referring now to FIGS. 51 and 52, there are shown two exemplary sets of object bags. In FIG. 51, there is shown the “b” handshape bag in which the objects “house”, “bag” and “whale” each utilize the “b” handshape. In FIG. 52, there is shown the objects “black”, “star” and “mouse”, which each utilize the “1” handshape. In an embodiment, at least 41 bags are provided, and each one of the bags contains at least 10 three-dimensional (3-D) objects. The objects categorized together in a single bag with one another share a key handshape. This is in contrast to the Montessori Method which uses phonetic object bags in which each object shares an initial sound.

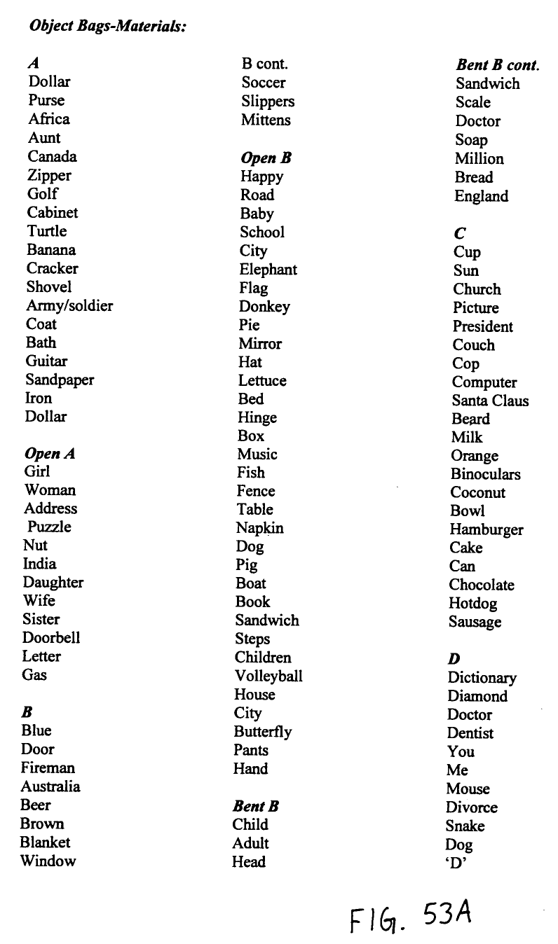

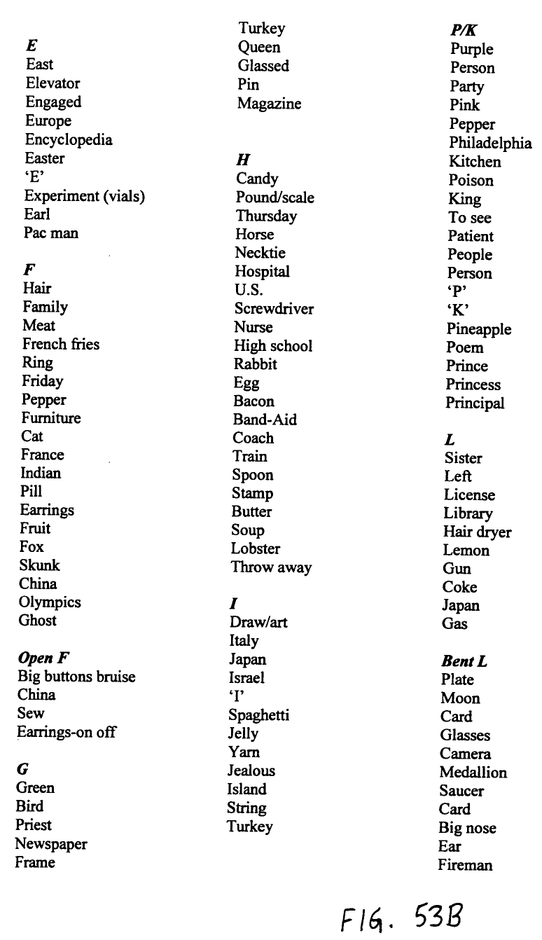

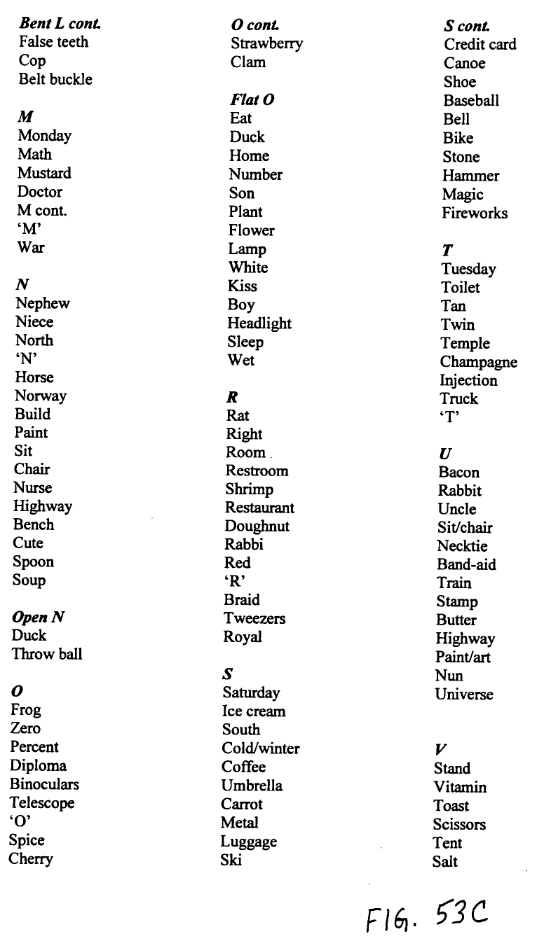

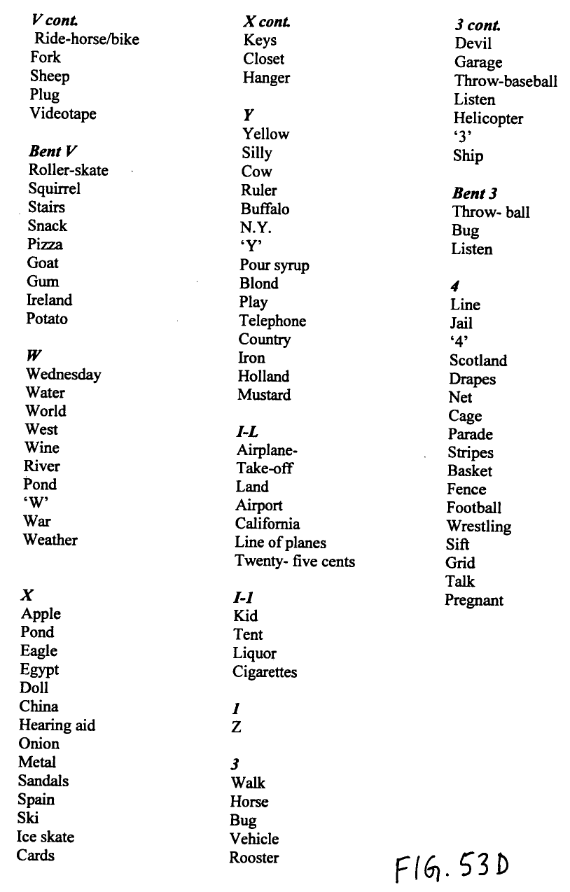

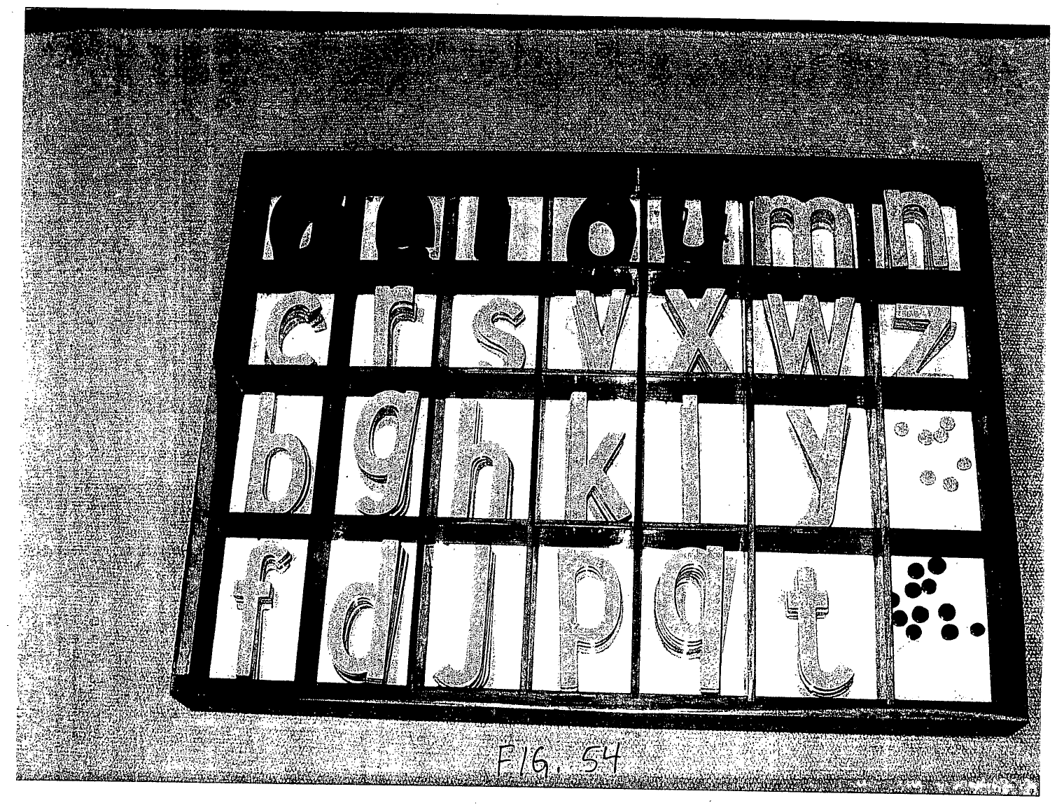

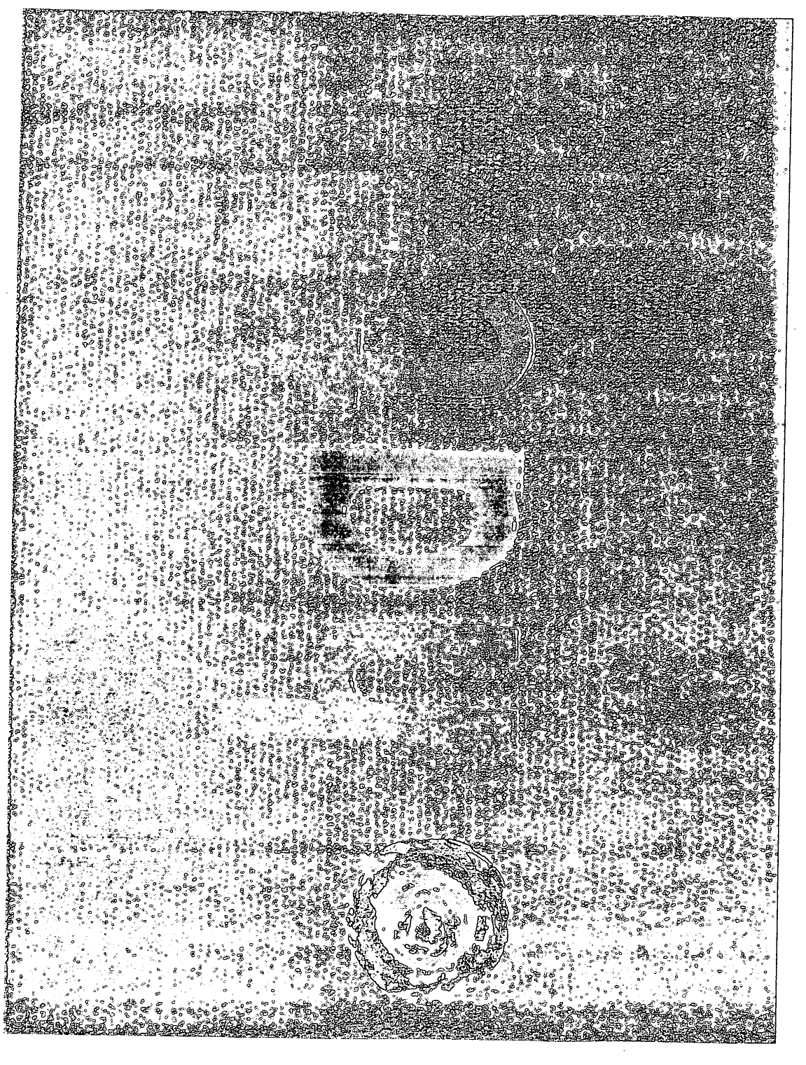

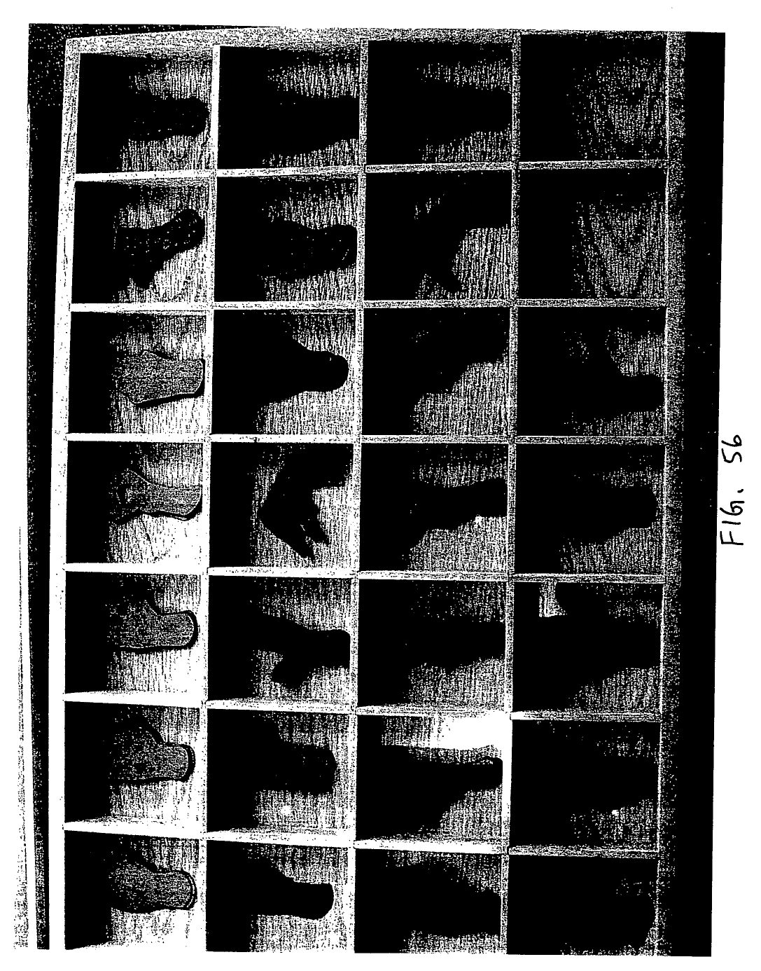

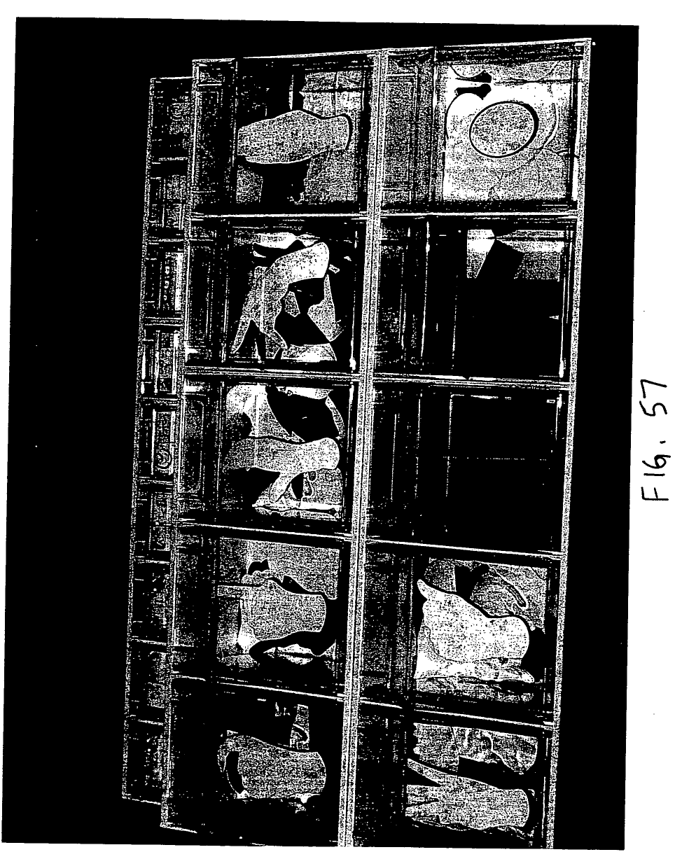

For example, see FIGS. 53A-53D for a list of objects grouped together with one another. The use of the object bags helps to establish a basic ASL vocabulary using concrete objects. The use of the object bags helps to emphasize the importance of the four components of a sign. These components include handshape, orientation, location, and movement. The use of the object bags introduce the moveable sign encoding system as outlined in the DASE curriculum.

In one embodiment, an object bag corresponds to a specific sandpaper handshape. A child places a sandpaper handshape at the base of the table, and the handshape is reviewed. An object bag that corresponds to the chosen handshape is retrieved from a shelf. The child removes objects from the bag and identifies each object. During the identification of the objects, an ASL dialog can be encouraged.

In another embodiment, a teacher has a bag containing random objects and 2-D, sign encoded labels of the handshapes therein. The child takes the bag to a rug and places the handshape labels on the upper edge of a vertical rug. The child then removes objects randomly and categorizes objects according to their handshape, creating columns of objects under their respective handshapes.

Looking at FIGS. 54 and 55, there is shown a moveable alphabet of the 26 English letters. This moveable alphabet is used in the Montessori Method. Vowels are shown in one color, which is blue, and consonants are shown in another color, which is pink/red. Using the letters from the moveable alphabet, the word “hat” is created next to its object.

Referring now to FIG. 56, there is shown a 2-D moveable manual alphabet consisting of 26 handshapes, which corresponds to the Montessori moveable alphabet of English letters shown in FIGS. 54 and 55. The moveable manual alphabet has 26 handshapes with separate colors to distinctly indicate vowels and consonant from one other. The handshapes are made from die cuts. Each handshape is either cut from red or blue paper or vinyl, depending on whether it is a consonant or a vowel. The moveable manual alphabet is housed in a similar box to the Montessori moveable alphabet and is arranged with the vowels displayed in the first row and then according to the size of the handshape from small to large. These 26 2-dimensional handshapes allow for a lasting visual impression of fingerspelling, a component of ASL.

Referring to FIGS. 57-60, there is shown the movable sign encoding system (MSES) comprising of at least 41 handshapes in 2-D die cut form with black, white, and ½-black/½-white coloring to accurately convey ASL. By using MSES a visual representation of an ASL thought can be analyzed and reviewed as long as needed to maximize retention and comprehension. The moveable sign encoding system uses all four components of a sign, which include handshape, orientation, location, and movement. The 41+ handshapes of MSES accurately embodies those handshapes used within ASL. Orientation of the palm, another critical component of a sign, is easily conveyed by the coloration of the 2-D die cut. The location is the position on the body, the face or in space where the sign is made. Generally, the hand(s) are positioned parallel to the floor unless a blue bar is provided to indicate that the hand(s) are positioned parallel to the wall. Movement is indicated by various symbols capturing the relative, absolute and contractual motion of any sign. In other words, how the hands move relative to other parts in space. See, for example the movement symbol list.

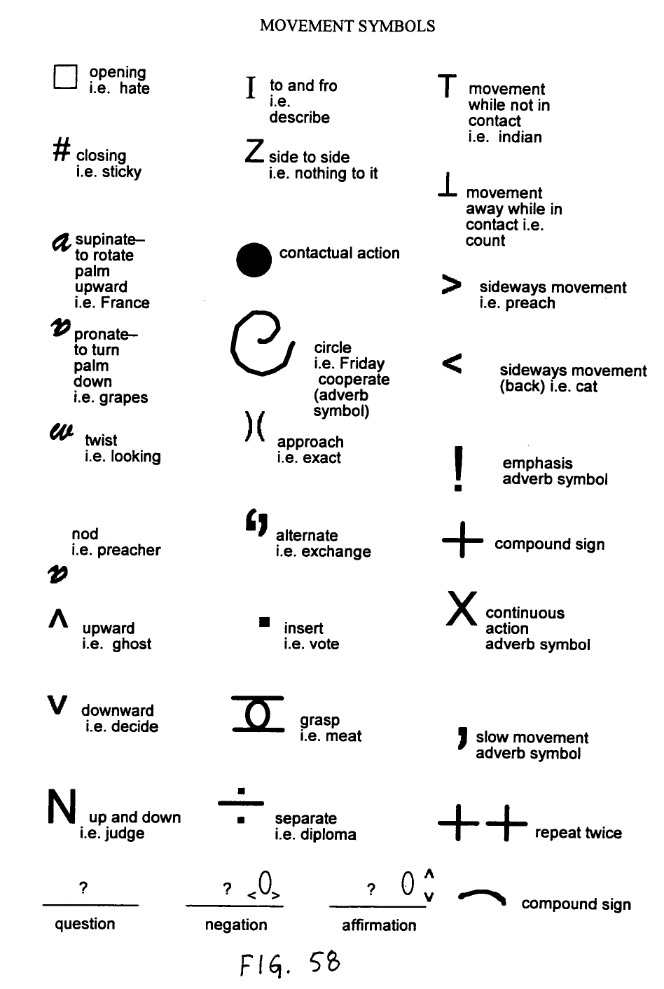

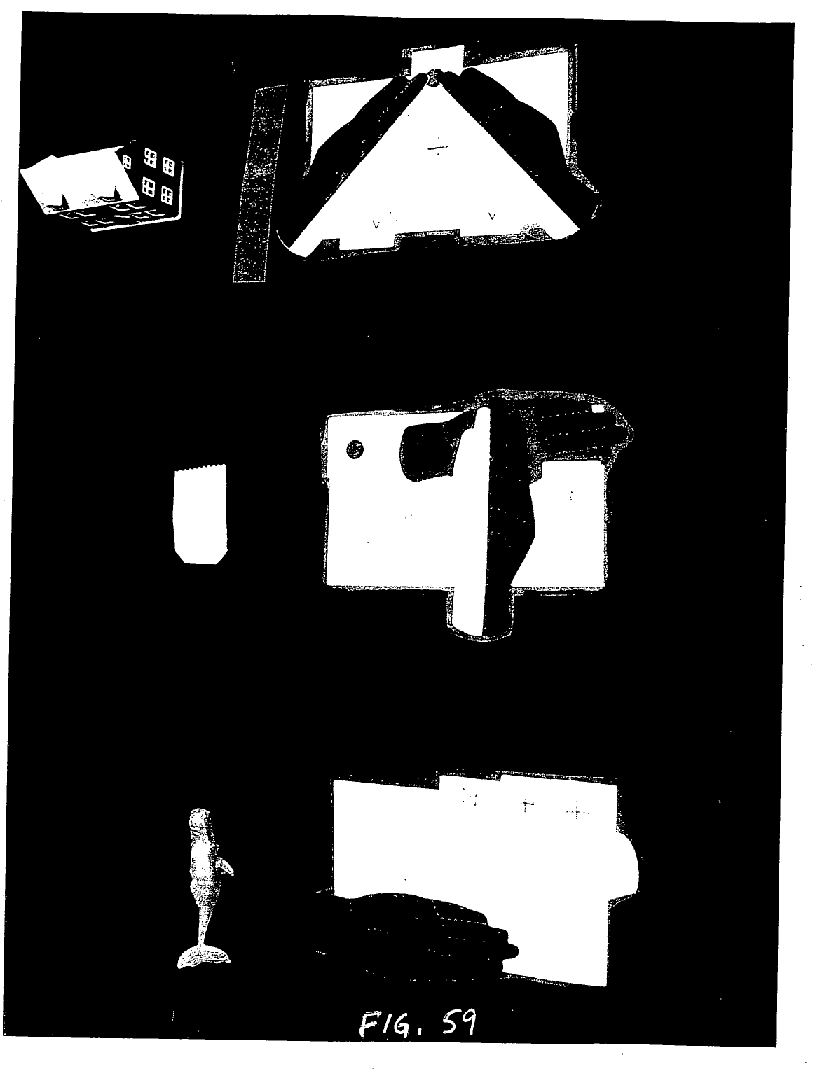

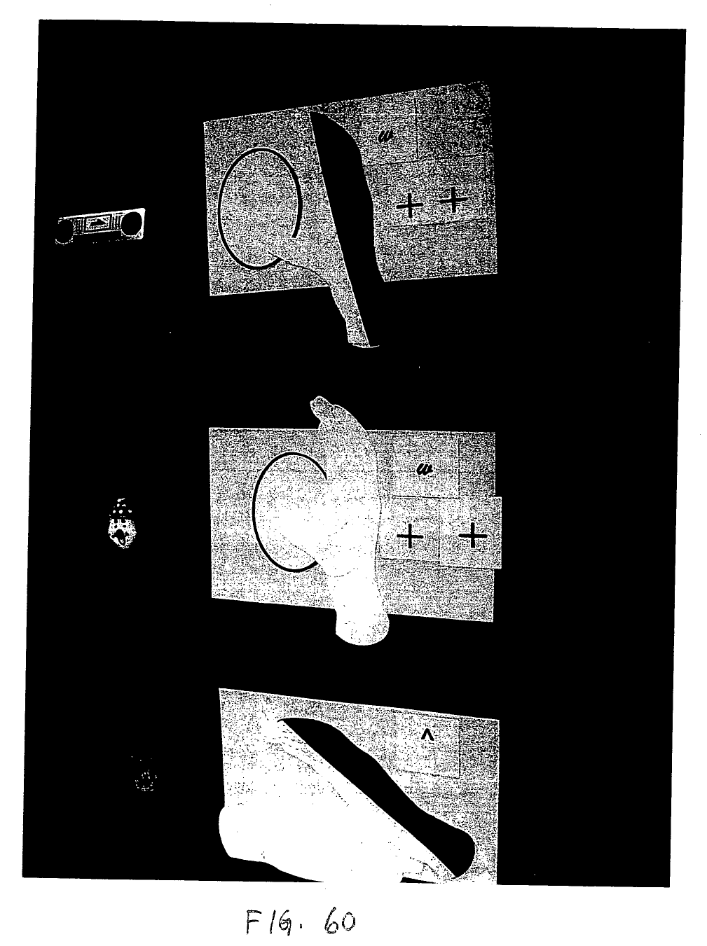

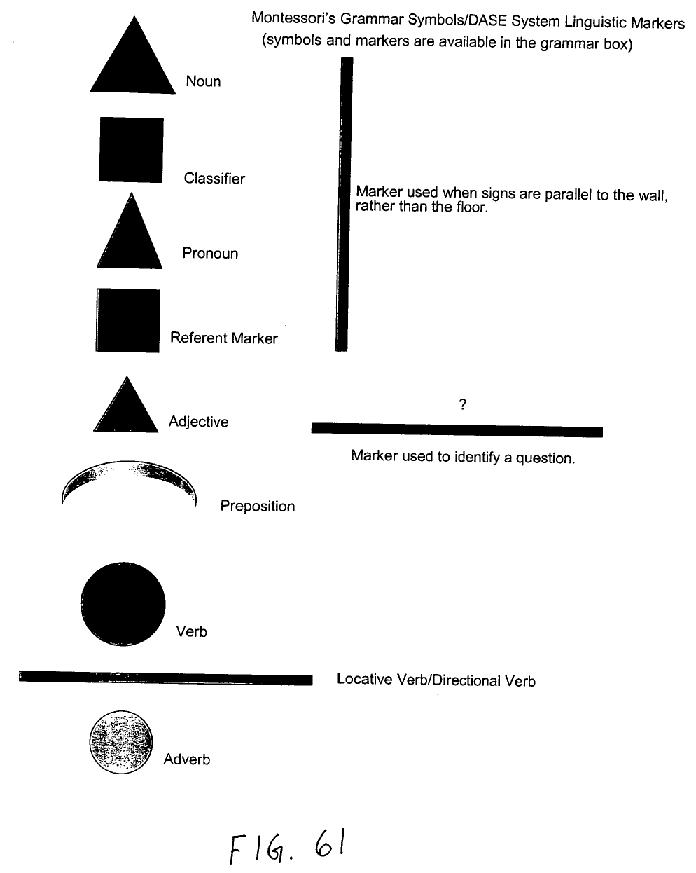

Orientation and location of handshapes 5 generally includes the following directions. The white, black and ½ black-½ white variants of handshape 5 indicate the orientation of a sign from the perspective of the signer, never from the perspective of the recipient. This configuration is useful when encoding and/or decoding ASL. The purpose is to indicate if the palm is facing the signer (white), or if the back of the hand is facing the signer (black), or if a side view of the hand is present (½ black-½ white) If the sign is to be executed parallel to the wall, a vertical blue rectangle is provided. Otherwise, without the vertical blue rectangle, the sign is executed parallel to the floor. Location and movement of handshapes 5 generally include directions provided by the movement symbols described in FIG. 58 and demonstrated in FIGS. 59 and 60.

The moveable sign encoding system helps the child in the exploration and analysis of his or her already known language. The moveable sign encoding system reproduces ASL in a cogent 2-dimensional form.

In addition, the moveable sign encoding system fosters literacy in ASL and provides the user with a foundational understanding of language which is later used when targeting English literacy.

In an exemplary embodiment, a cabinet is provided having at least 41 pull-down drawers each containing a handshape of American Sign Language. In each drawer, three forms of each handshapes are present. These forms of the handshapes include fully black, white or ½ black-½ white handshapes depicting the orientation of the hand. The cabinet is child-size and therefore is twice the width for easy access. In one embodiment, 5 large drawers across and five down on one side and five across four down on the other. Resting on top of the large drawers are smaller drawers (9 across) and each drawer contains movement symbols (see symbol chart of FIG. 58) and various arrows depicting the movement of the sign. Ovals are used to indicate that the sign is made on the face (faces have eye-brows and mouths to indicate facial expression). A blue rectangle is present to indicate when a sign is parallel to the floor rather than the wall.

For example, some sample preparatory lesson to MSES are as follows:

Preferably, the child should know at least 12-15 sandpaper handshapes before the moveable sign encoding system is introduced.

First, the child assists in straightening the handshapes in the cabinet so as to recognize where each handshape is placed and in what compartment.

Second, 4-5 sandpaper handshapes that are markedly visually different are placed at a table; the moveable sign encoding system remains stationary. The teacher asks the child using ASL, “Do you remember this handshape?” After a child responds in ASL, the teacher asks, “Can you find this handshape in the cabinet?” The child searches for the handshape in the cabinet and then returns to the table. The teacher asks the child, “What did you bring me?” and the child responds by forming the handshape and then returns the handshape to the cabinet. This is repeated for the remaining handshapes. Alternatively, the teacher signs a handshape to the child and follows a similar procedure as above. It is expected that the child will form the handshape prior to returning it to the cabinet.

Third, there is an available pre-laminated, oak-tag card on which is placed the handshapes of the moveable sign encoding system in the appropriate colors. The child places these cards on the rug and then retrieves the corresponding handshape from the sign encoding cabinet. The child then places the matching handshape over the pre-laminated one. This activity can be done in order and out of order. Refer to the lesson plan for the MSES, which is contained in U.S. Provisional Patent Application Ser. No. 60/568,012, and is hereby incorporated herein by reference, for a deeper appreciation of the formal lesson presentation.

Referring now to FIGS. 61-68, there is shown an embodiment of a grammar system for use with ASL. Referring now to FIG. 61, there is shown various geometric shapes used to identify grammatical elements generally found in written language. The Montessori Method uses various geometric shapes in a plurality of colors to identify grammatical elements found in written language. In an embodiment, four elements have been added to the Montessori grammar system to incorporate syntactical components of ASL that are not present in English. These elements include the classifier, the referent marker, the locative/directional verb, and the indication of the presence of a question. The classifier is shown as a black square and gives a noun the ability to move though space. The referent marker identifies the position of an object in space for the duration of the conversation. In ASL, the referent marker can also function as a pronoun comparable to how written English uses pronouns. The locative/directional verb indicates a verb phrase where movement conveys a key element and is crucial to the understanding of the intended message. The indication of the presence of a question is indicated by a change in facial expression, i.e. raised eyebrows.

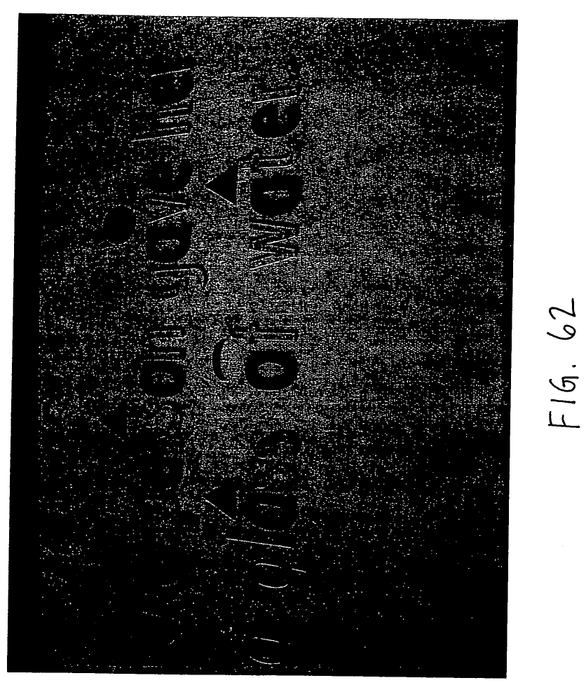

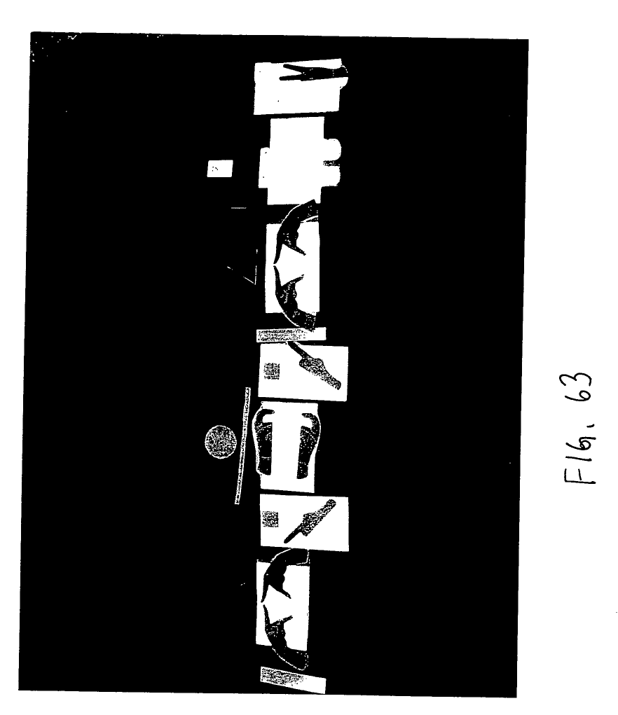

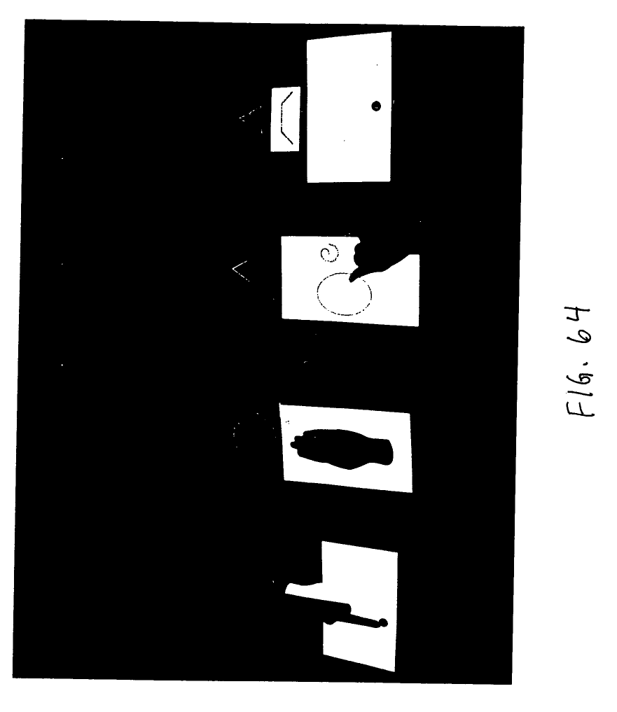

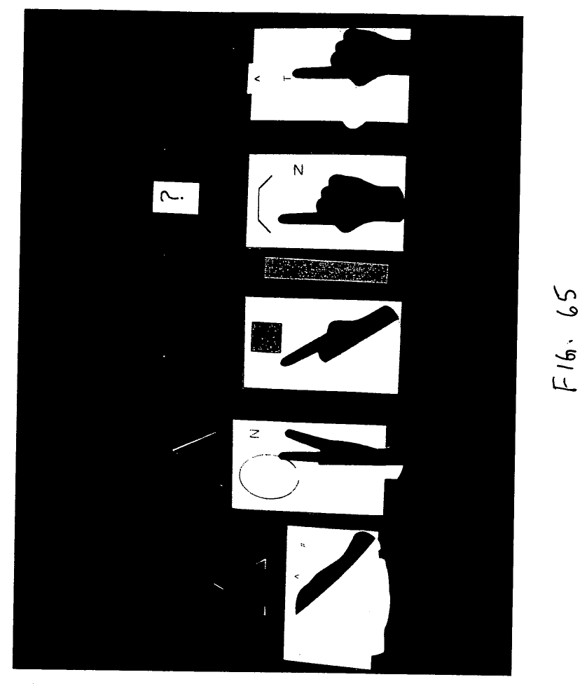

FIG. 62 illustrates an English sentence which reads “the person gave her a glass of water” using existing Montessori language material, the Moveable Alphabet.

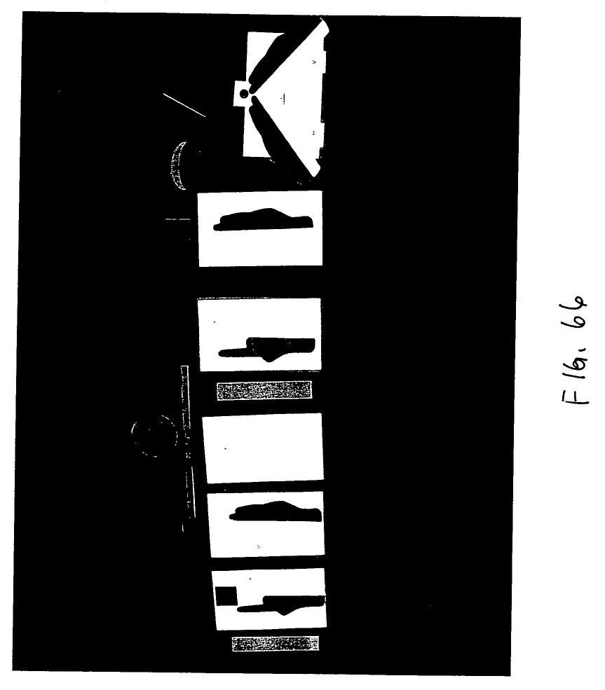

FIG. 63 illustrates an ASL sentence with a meaning similar to the sentence shown in FIG. 62. In the ASL sentence, the referent marker (the third and fifth symbol from the left) is used to denote that a person gave (the fourth symbol from the left is a locative verb) a glass of water to another person.

FIG. 64 illustrates an ASL sentence which means in English, “I was raised by my Aunt”.

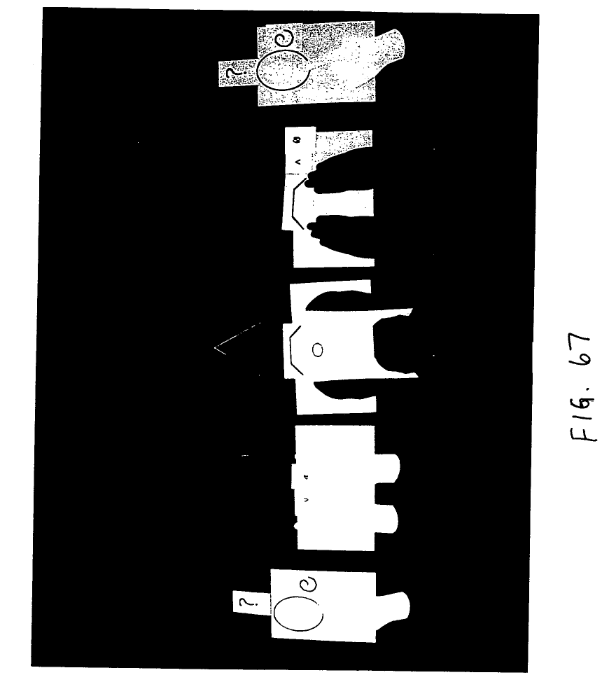

FIG. 65 illustrates another ASL sentence which means in English, “Where do I pay for this bottle of water?” The indication of a question necessitates a change in facial expressions, in this case the raising of the eyebrows.

FIG. 66 illustrates an ASL sentence which means in English, “The person entered the car, drove in a variety of directions and once arriving at said destination, the person exited the car and entered the house.” The second, third, sixth and seventh symbols are classifiers.

FIG. 67 illustrates an ASL sentence which means in English, “Who walked to class?”

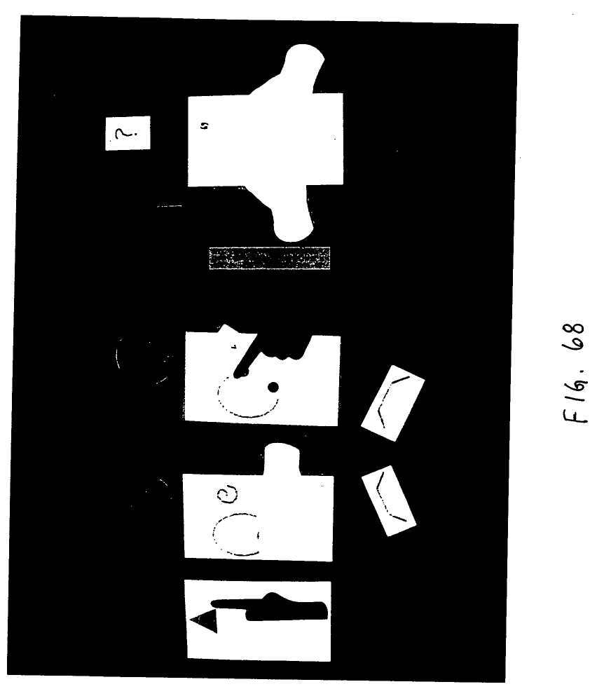

FIG. 68 illustrates an ASL sentence which means in English, “Are you hearing or are you Deaf?”

In an embodiment, a computer program is provided for word processing of ASL under the DASE system. This makes “written” media in ASL possible. Books can then be translated into ASL using the DASE system. When targeting English literacy, the DASE system provides the foundational understanding of language and can then be compared and contrasted with written English.

1. An educational system for promoting literacy in American Sign Language, the system comprising a plurality of two-dimensional handshapes corresponding to three-dimensional hand configurations of American Sign Language, at least one of the plurality of two-dimensional handshapes having a reference marker to show the orientation of a hand of a signer when imitating at least one of the plurality of two-dimensional handshapes.

2. An educational system according to claim 1 wherein the reference marker is at least one of a white section and a black section positioned on at least one of the plurality of two-dimensional handshapes.

3. An educational system for promoting literacy in American Sign Language, the system having a plurality of three-dimensional handshapes corresponding to hand configurations of American Sign Language, each one of the plurality of three-dimensional handshapes extending from a base portion, and the base portion configured to allow selective positioning of at least two of the three-dimensional handshapes adjacent to one another.

4. An educational system according to claim 3 wherein the base portion further comprises a representation of an English letter so as to identify the corresponding three-dimensional handshape.

5. An educational system according to claim 4 wherein the representation of the English letter is a sandpaper letter.

6. An educational system according to claim 3 wherein the base portion further comprises a two-dimensional representation of the corresponding three-dimensional handshape.

7. An educational system according to claim 5 wherein the two-dimensional representation is a sandpaper handshape.

8. An educational system for promoting literacy in American Sign Language, the system comprising object bags having a plurality of items therein, wherein each of the plurality of items are related to a specific handshape.

9. An educational system according to claim 8 wherein the specific handshape is an “A” handshape, and further wherein the plurality of items related to the “A” handshape comprise a dollar, a purse, a zipper, and a banana.

10. A moveable sign encoding system for promoting literacy in American Sign Language, the system comprising at least 41 two-dimensional handshapes of American Sign Language in which 26 two-dimensional handshapes of the at least 41 handshapes correspond to an alphabet of English letters.

11. A moveable manual alphabet as a subset of the moveable sign encoding system according to claim 10 wherein the 5 of the 26 two-dimensional handshapes corresponding to vowels in the English language are colored blue, and the 21 of the 26 two-dimensional handshapes corresponding to consonants in the English language are colored red/pink.

12. A moveable sign encoding system according to claim 10 wherein the at least 41 two-dimensional handshapes are selectively positionable relative to one another to form a visual grammatical framework of American Sign Language.

13. A moveable sign encoding system according to claim 10 further comprising a set of symbols to indicate movement of the two-dimensional handshapes.

14. A moveable sign encoding system, according to claim 13, wherein a path taken by the two-dimensional handshapes to convey an idea is identified by at least one of the set of symbols chosen from a group consisting of pictorial representations reflecting at least one of absolute, relative to one another, and contactual movement.

15. A moveable sign encoding system according to claim 13 further comprising movement symbols to indicate positioning of at least one of the two-dimensional handshapes.

16. A moveable sign encoding system according to claim 10 wherein a reference marker of at least one of the two-dimensional handshapes provides the orientation of a hand of a signer when imitating at least one of the plurality of two-dimensional handshapes.

17. A moveable sign encoding system according to claim 16 wherein the reference marker indicates if the palm is facing the signer with a white background, or if the back of the hand is facing the signer with a black background, or if a side view of the hand is present with ½ black and ½ white background.

18. A grammar system for encoding American Sign Language, the system comprising geometric shapes to identify grammatical elements of American Sign Language.

19. A grammar system according to claim 18 wherein the grammar system further comprises syntactical elements, and wherein the syntactical elements comprise a classifier, a referent marker, a locative/directional verb, and an indicator for indicating the presence of a question.

20. A grammar system according to claim 18 wherein a visual presentation created by the geometric shapes corresponds to grammatical elements configured for syntactical analysis.

21. An educational method for promoting literacy in American Sign Language, the method comprising:
encoding a lasting visual impression using two-dimensional handshapes, grammatical markers and movement symbols representing American Sign Language; and
decoding the lasting visual impression using two-dimensional handshapes, grammatical markers and movement symbols of American Sign Language.

22. An educational method for promoting literacy in American Sign Language, the method comprising:
selecting at least two two-dimensional handshapes; and
positioning the at least two two-dimensional handshapes to encode and decode an American Sign Language message.

23. An educational method according to claim 22 further comprising the step of providing a symbol to indicate the movement of at least one of the two-dimensional handshapes.

24. An educational method for promoting literacy in American Sign Language, the method comprising:
selecting at least two two-dimensional handshapes;
positioning the at least two two-dimensional handshapes relative to one another;
identifying at least one symbol to identify movement of the at least one of the two two-dimensional handshapes; and
providing at least one geometric shape relative to the at least two two-dimensional handshapes so as to provide a grammatical structure of American Sign Language.
